(19) United States
(12) Patent Application Publication
(10) Pub. No.: US 2026/0186842 A1
(43) Pub. Date: Jul. 2, 2026

(54) CONVOLUTION ACCELERATOR, MICRO-CONTROLLER CIRCUIT AND CONTROL METHOD

(71) Applicant: Nuvoton Technology Corporation, Hsinchu Science Park (TW)

(72) Inventor: Shao-Heng HUNG, Taichung City (TW)

(21) Appl. No.: 19/388,249

(22) Filed: Nov. 13, 2025

(30) Foreign Application Priority Data
Dec. 26, 2024 (TW) 113150788

(51) Int. Cl. G06F 9/50; G06N 3/0464

(52) U.S. Cl. CPC G06F 9/5027; G06N 3/0464

(57) ABSTRACT

A convolution accelerator performing the convolution operations of a plurality of convolution layers on data stored in a storage circuit is provided. The convolution accelerator includes a plurality of convolution calculation circuits, a detection circuit, and a control circuit. A convolution operation is performed in response to one of the convolution calculation circuits being turned on. The detection circuit detects the access state of the storage circuit within a fixed time interval to generate a detection signal. The control circuit dynamically adjusts the number of convolution calculation circuits to be turned on for the convolution operations of each of the convolution layers according to the detection signal.

### CROSS REFERENCE TO RELATED APPLICATIONS

This Application claims priority of Taiwan Patent Application No. 113150788, filed on Dec. 26, 2024, the entirety of which is incorporated by reference herein.

### BACKGROUND OF THE INVENTION

### Field of the Invention

The invention relates to a convolution accelerator, and more particularly it relates to a convolution accelerator that dynamically adjusts the number of convolution calculation circuits to be turned on.

### Description of the Related Art

In recent years, deep neural networks have been widely used in various fields. Convolutional neural networks (CNN) have become the mainstream. As the model complexity increases, the CNN hardware architecture also becomes more complex. Taking image identification as an example, assume that the frame rate of a CNN hardware architecture is 120 Hz. If the user does not need 120 Hz frame rate, or the camera can only support a 60 Hz frame rate, more circuits in the CNN hardware architecture will be idle. The idle circuits reduces hardware usage and increases the power consumption.

### BRIEF SUMMARY OF THE INVENTION

In accordance with an embodiment, a convolution accelerator performs convolution operations of a plurality of convolution layers on data stored in a storage circuit and comprises a plurality of convolution calculation circuits, a detection circuit, and a control circuit. A convolution operation is performed in response to one of the convolution calculation circuits being turned on. The detection circuit detects the access state of the storage circuit within a fixed time interval to generate a detection signal. The control circuit dynamically adjusts the number of convolution calculation circuits to be turned on for each of the convolution layer according to the detection signal.

In accordance with another embodiment, a micro-controller circuit comprises a sensing circuit, a storage circuit, a convolution accelerator, and a processing circuit. The sensing circuit detects an external image to generate input data. The storage circuit stores the input data. The convolution accelerator performs convolution operations of a plurality of convolution layers on the input data and comprises a plurality of convolution calculation circuits, a detection circuit, and a control circuit. A convolution operation is performed in response to one of the convolution calculation circuits being turned on. The detection circuit detects the access state of the storage circuit within a fixed time interval to generate a detection signal. The control circuit dynamically adjusts the number of convolution calculation circuits to be turned on for the convolution operations of the convolution layers according to the detection signal. The processing circuit triggers the convolution accelerator and identifies the external image according to calculation results of the convolution calculation circuits.

In accordance with a further embodiment, a control method for performing convolution operations of a plurality of convolution layers is provided. An exemplary embodiment of the control method is described in the following paragraph. The picture data is stored in a storage circuit. The access state of the storage circuit within a fixed time interval is detected. The number of convolution calculation circuits to be turned on in each convolution layer in a first processing period is determined according to the access state. The first calculation results generated by the turned-on convolution calculation circuits in the first processing period are detected. The number of convolution calculation circuits to be turned on in each convolution layer in a second processing period is determined according to the amount of data of the first calculation results and the access state. The second calculation results generated by the turned-on convolution calculation circuits in the second processing period are detected. The frame rate is detected to determine the processing time. The total time of the first processing period and the second processing period is calculated. The difference between the processing time and the total time of the first processing period and the second processing period is calculated. The number of convolution calculation circuits to be turned on in each convolution layer in a third processing period is determined according to the amount of data of the second calculation results and the difference between the processing time and the total time of the first processing period and the second processing period.

The control method for performing the convolution operations of a plurality of convolution layers may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes a micro-controller circuit and a convolution accelerator for practicing the disclosed method.

### BRIEF DESCRIPTION OF THE DRAWINGS

The present invention can be more fully understood by reading the subsequent detailed description and examples with references made to the accompanying drawings, wherein:

FIG. 1 is a schematic diagram of an exemplary embodiment of a micro-controller circuit according to various aspects of the present disclosure.

FIG. 2 is a schematic diagram of an exemplary embodiment of a convolution accelerator according to various aspects of the present disclosure.

FIG. 3 is a flowchart of an exemplary embodiment of a control method for performing a convolution operation according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

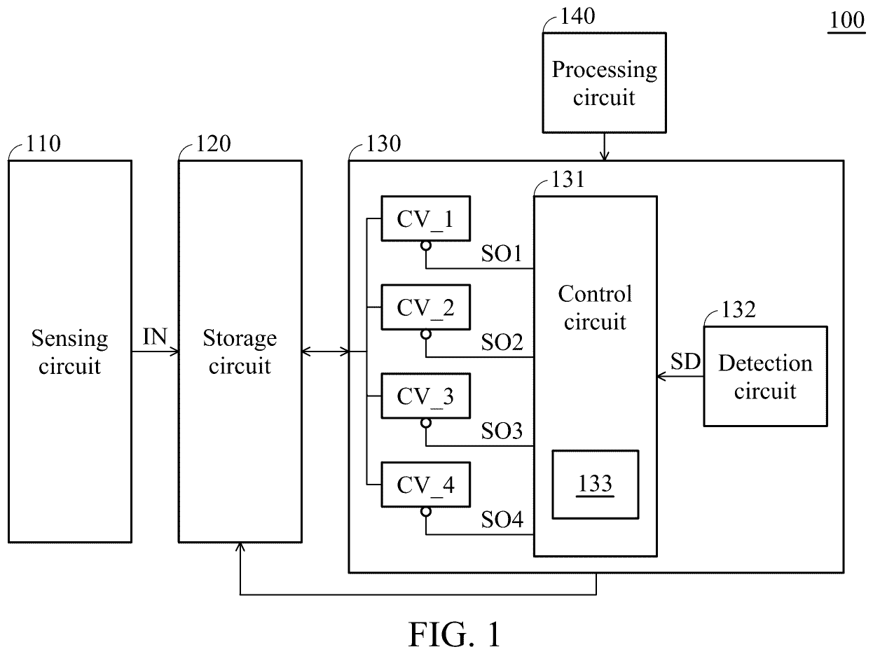

FIG. 1 is a schematic diagram of an exemplary embodiment of a micro-controller circuit according to various aspects of the present disclosure. As shown in FIG. 1, the micro-controller circuit 100 comprises a sensing circuit 110, a storage circuit 120, a convolution accelerator 130 and a processing circuit 140. The sensing circuit 110 detects an external state to generate input data IN. The type of sensing circuit 110 is not limited in the present disclosure. In one embodiment, the sensing circuit 110 is an image sensor to detect an external image. In this case, the input data IN is frame data. In another embodiment, the sensing circuit 110 is a sound sensor to detect an external sound.

The storage circuit 120 stores the input data IN. The structure of storage circuit 120 is not limited in the present disclosure. In one embodiment, the storage circuit 120 comprises a memory and a memory controller. The memory controller accesses the memory according to an external command. In some embodiments, the storage circuit 120 comprises a volatile memory, such as a static random-access memory (SRAM).

The convolution accelerator 130 accesses the storage circuit 120 to perform the convolution operations of multiple convolution layers on the input data IN. In this embodiment, the convolution accelerator 130 comprises convolution calculation circuits CV_1˜CV_4. Taking the convolution calculation circuit CV_1 as an example, when the convolution calculation circuit CV_1 is turned on, the convolution calculation circuit CV_1 performs a convolution operation. The number of convolution calculation circuits is not limited in the present disclosure. In other embodiment, the convolution accelerator 130 comprises the more or the fewer convolution calculation circuits.

In some embodiments, the convolution accelerator 130 further comprises a control circuit 131 and a detection circuit 132. The detection circuit 132 detects the operation state of the micro-controller circuit 100 to generate a detection signal SD. In one embodiment, the detection circuit 132 is a bus monitor. In this case, the detection circuit 132 detects the access state of the storage circuit 120 within a fixed time interval. The access state may be the idle time and free space of the storage circuit 120.

For example, the bus monitor collects signals sent to the storage circuit 120 from other circuits (other than the convolution accelerator 130), such as a read/write signal Read/Write, a ready signal Ready, and a response signal Response. The bus monitor calculates the access time ratio of the storage circuit 120 in a fixed time interval according to the collected information. For example, in 1000 cycles, 30% of the cycles of the storage circuit 120 are accessed by other circuits. In this case, the storage circuit 120 is idle in 70% of the cycles.

The control circuit 131 dynamically adjusts the number of convolution calculation circuits to be turned on in different processing periods according to the detection signal SD. In each processing period, the turned-on convolution calculation circuits may perform the convolution operations in multiple convolution layers. For example, in a first processing period, the control circuit 131 first determines how many convolution calculation circuits can be satisfied by the idle time and idle space of the storage circuit 120 according to the detection signal SD before the convolution operation of each convolution layer is performed. Then, the control circuit 131 turns on the maximum number of convolution calculation circuits to perform the convolution operation according to the determination result. In the first processing period, the number of the turned-on convolution calculation circuits is called a first number.

For example, assume that the control circuit 131 uses the detection signal SD to obtain that the storage circuit 120 will not be accessed by other circuits in 70% of the 1000 cycles. At this time, the control circuit 131 may turn on the convolution calculation circuits CV_1˜CV_3. However, if the control circuit 131 turns on the convolution circuits CV_1˜CV_4, since the bandwidth of the storage circuit 120 can only satisfy three convolution circuits (such as CV_1˜CV_3), a convolution circuit (such as CV_4) cannot access the storage circuit 120 even though it is turned on. The idle convolution calculation circuit will cause excessive power consumption. However, if the bandwidth of the storage circuit 120 can satisfy the operation of four convolution calculation circuits, the control circuit 131 may turn on all the convolution calculation circuits (such as CV_1˜CV_4).

In other embodiments, the control circuit 131 writes the calculation results of each convolution calculation circuit into the storage circuit 120. The detection circuit 132 detects the amount of data of the calculation results stored in the storage circuit 120. In a second processing period, the control circuit 131 determines the number of convolution calculation circuits to be turned on according to the detection result of the detection circuit 132. At this time, the number of convolution calculation circuits to be turned on in the second processing period is called a second number.

For example, if the amount of data of the calculation results generated in the first processing period is lower than a threshold value, a few convolution calculation circuits are turned on by the control circuit 131, such as turning on the convolution calculation circuits CV_1 and CV_2, and turning off the convolution calculation circuits CV_3 and CV_4. At this time, if the control circuit 131 further considers the idle time and the idle space of the storage circuit 120, the turned-on convolution calculation circuits can provide the best performance. For example, even if the amount of data of the calculation results is lower than a threshold value, if the bandwidth of the storage circuit 120 is insufficient to satisfy the operation of the convolution calculation circuits CV_1 and CV_2, the control circuit 131 may only turn on the convolution calculation circuit CV_1.

In some embodiments, the detection circuit 132 further detects a frame rate. In a third processing period, the control circuit 131 determines the frames per second (FPS) according to the detection result of the detection circuit 132. The control circuit 131 determines the remaining processing time according to the FPS. In this case, the control circuit 131 turns on the least convolution calculation circuit according to the remaining processing time. The turned-on convolution calculation circuit performs the convolution operation on the calculation results generated by the second processing period. Therefore, the power consumption of the micro-controller circuit is low and the overall hardware utilization rate is improved. In the third processing period, the number of turned-on convolution calculation circuits is called to a third number. In one embodiment, the first number is higher than the second number, and the second number is higher than the third number. In other embodiments, the first number may be equal to the second number and higher than the third number.

The invention does not limit how the control circuit 131 turns on the convolution calculation circuits CV_1˜CV_4. In one embodiment, the control circuit 131 uses the activation signals SO1˜SO4 to control the convolution calculation circuits CV_1˜CV_4. Taking the convolution calculation circuit CV_1 as an example, when the activation signal SO1 is enabled, the convolution calculation circuit CV_1 is turned on. When the activation signal SO1 is disabled, the convolution calculation circuit CV_1 is turned off. In another embodiment, the control circuit 131 sends an activation command (not shown in FIG. 1) to the convolution calculation circuits CV_1˜CV_4. In this case, the activation command may have four bits. Each bit corresponds to one convolution calculation circuit. When the value of a first bit is equal to a first value (e.g., the value 1), the corresponding convolution calculation circuit (e.g., CV_1) starts working. When the value of the first bit is equal to a second value (e.g., the value 0), the corresponding convolution calculation circuit (e.g., CV_1) stops working. In other embodiments, the control circuit 131 controls the clock signals of the convolution calculation circuits CV_1˜CV_4. Taking the convolution calculation circuit CV_1 as an example, when the control circuit 131 stops providing a clock signal to the convolution calculation circuit CV_1, the convolution calculation circuit CV_1 does not work. When the control circuit 131 provides the clock signal to the convolution calculation circuit CV_1, the convolution calculation circuit CV_1 starts to work.

In some embodiments, the control circuit 131 uses a look-up table (LUT) or a machine learning model to adjust the number of convolution calculation circuits to be turned on for each convolution layer. In this case, the control circuit 131 may comprise a storage circuit 133 for storing a lookup table or a machine learning model.

In one embodiment, the storage circuit 133 stores a LUT. The lookup table records multiple situations. The control circuit 131 finds a suitable situation from the LUT according to the detection signal SD, the calculation results of the first processing period, the calculation results of the second processing period, the remaining time, and the frame rate. Then, the control circuit 131 finds a number value corresponding to the suitable situation from the LUT. The control circuit 131 determines the number of convolution calculation circuits to be turned on according to the number value. In this case, each situation corresponds to a detection signal SD, a number of first calculation results (i.e., the amount of operations required for the second processing period), a number of second calculation results (i.e., the amount of operations required for the third processing period), a remaining time, and a frame rate.

In one embodiment, the storage circuit 133 stores a machine learning model. In a training period, the control circuit 131 inputs training data to the machine learning model to train the machine learning model to predict the appropriate number of convolution calculation circuits to be turned on before the convolution operation of each convolution layer is performed on the input data IN. In this case, the training data includes a plurality of access states (such as the output of the detection circuit 132) , a plurality of calculation results (such as the remaining amount of operation after performing the convolution operation on different frame data), and a plurality of time values (such as the remaining processing time). The control circuit 131 uses the pre-trained machine learning model to determine the number of convolution calculation circuits to be turned on for each convolution layer. The type of machine learning model is not limited in the present disclosure. In one embodiment, the machine learning model is a recurrent neural network (RNN), such as a long short-term memory network model or a gated recurrent unit network model.

The processing circuit 140 is configured to trigger the convolution accelerator 130 and perform an identify operation according to the calculation results of the convolution calculation circuits CV_1˜CV_4, such as identifying whether an external image matches a target image. In some embodiments, the processing circuit 140 performs a fully connected layer operation on the calculation results of the convolution calculation circuits CV_1˜CV_4.

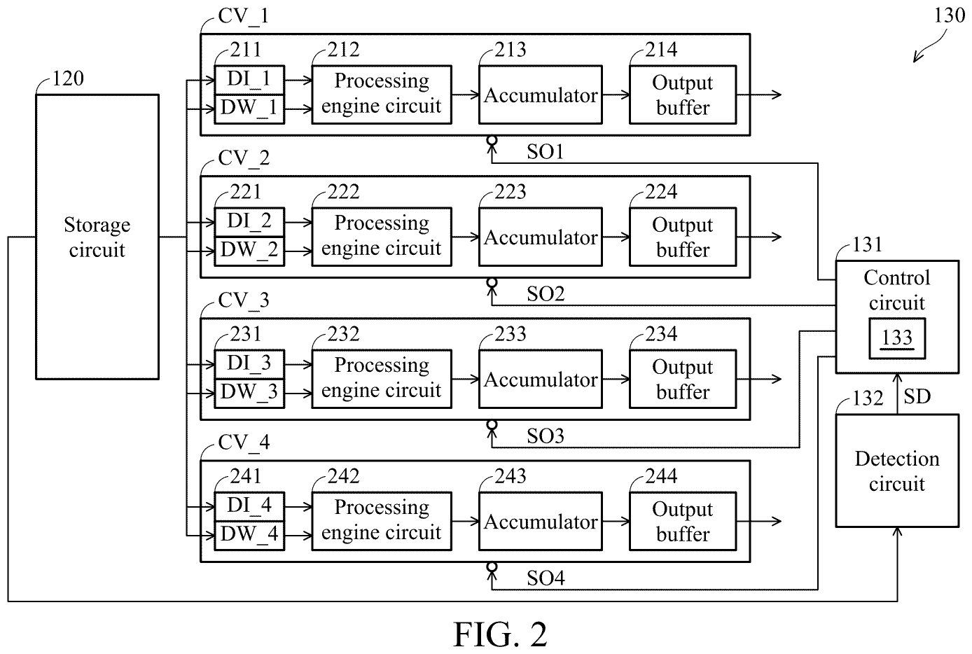

FIG. 2 is a schematic diagram of an exemplary embodiment of the convolution accelerator 130 according to various aspects of the present disclosure. The convolution accelerator 130 comprises convolution calculation circuits CV_1˜CV_4. The convolution calculation circuit CV_1 comprises an input buffer 211, a processing engine circuit 212, an accumulator 213 and an output buffer 214. The convolution calculation circuit CV_2 comprises an input buffer 221, a processing engine circuit 222, an accumulator 223 and an output buffer 224. The convolution calculation circuit CV_3 comprises an input buffer 231, a processing engine circuit 232, an accumulator 233 and an output buffer 234. The convolution calculation circuit CV_4 comprises an input buffer 241, a processing engine circuit 242, an accumulator 243 and an output buffer 244. Since the operations of the convolution calculation circuits CV_1˜CV_4 are the same, the convolution calculation circuit CV_1 is given as an example to describe the operation of the convolution calculation circuit CV_1.

The input buffer 211 stores data DI_1 and a plurality of weight values DW_1. In one embodiment, the storage circuit 120 provides the data DI_1 and the weight values DW_1. The data DI_1 is a part of the input data IN. In some embodiments, the data DI_1 is an input feature map (IFM). In this case, the data DI_1 may be a 4×4 matrix. In other embodiments, the weight value DW_1 is a 3×3 matrix.

The processing engine circuit 212 calculates the data DI_1 and the weight values DW_1 to generate a plurality output results. In one embodiment, the processing engine circuit 212 uses a Winograd algorithm to perform a convolution operation on the data DI_1 and the weight values DW_1.

The accumulator 213 accumulates the output results generated by the processing engine circuit 212 to generate an accumulated result. In one embodiment, the accumulator 213 writes the output result generated by the processing engine circuit 212 into the output buffer 214. When the processing engine circuit 212 generates a new output result, the accumulator 213 reads the previous output result from the output buffer 214, adds the new output result to the previous output result, and writes the added result into the output buffer 214 to replace the previous output result.

The output buffer 214 stores the accumulated result of the accumulator 213. In one embodiment, the output buffer 214 writes the final accumulated result into the storage circuit 120. In this case, the detection circuit 132 determines the remaining data that needs to be calculated by the convolution operation according to the multiple accumulation result stored in the storage circuit 120.

In some embodiment, the control circuit 131 controls the convolution calculation circuits CV_1˜CV_4 via the activation signals SO1˜SO4. Taking the convolution calculation circuit CV_1 as an example, when the control circuit 131 enables the activation signal SO1, the convolution calculation circuit CV_1 starts to perform a convolution operation on the data DI_1 and the weight value DW_1. When the control circuit 131 disables the activation signal SO1, the convolution calculation circuit CV_1 stops performing the convolution operation on the data DI_1 and the weight value DW_1. In other embodiments, the control circuit 131 may stop providing a clock signal (not shown) to the input buffer 211, the processing engine circuit 212, the accumulator 213, and the output buffer 214 via the activation signal SO1.

In a first processing period, the detection circuit 132 detects the access state of the storage circuit 120 within a fixed time interval to generate a detection signal SD. In one embodiment, the detection circuit 132 detects the idle time and the idle space of the storage circuit 120 within a fixed time interval. In this case, before the convolution operation of each convolution layer is performed, the control circuit 131 determines how many convolution calculation circuits need to be turned on according to the idle time and idle space of the storage circuit 120 within a fixed time interval. For example, when the idle time and the idle space of the storage circuit 120 within a fixed time interval meet a first predetermined condition, the control circuit 131 turns on the convolution calculation circuits CV_1˜CV_4. When the idle time and the idle space of the storage circuit 120 within the fixed time interval meet a second predetermined condition, the control circuit 131 turns on the convolution calculation circuits CV_1˜CV_3.

In the first processing period, the amount of data to be processed is relatively large, so the control circuit 131 turns on the maximum number of convolution calculation circuits according to the access status of the storage circuit 120. The turned-on convolution calculation circuits perform a convolution operation to generate a multiple calculation results. The calculation results may be written into the storage circuit 120.

In a second processing period, the control circuit 131 or the detection circuit 132 determines the amount of remaining data from the calculation results. Before the convolution operation of each convolution layer is performed, the control circuit 131 determines how many convolution calculation circuits need to be turned on according to the amount of remaining data. In some embodiments, the control circuit 131 determines the number of turned-on convolution calculation circuits according to the amount of remaining data and the access status of the storage circuit 120. At this time, the number of turned-on convolution calculation circuits (or the second number) may be the same as or less than the number of turned-on convolution calculation circuits in the first processing period (or the first number).

In a third processing period, the control circuit 131 or the detection circuit 132 obtains the total processing time (e.g., 1/60 second) of each frame according to a frame rate. The control circuit 131 or the detection circuit 132 calculates the total time of the first and second processing periods. Before the convolution operation of each convolution layer is performed, the control circuit 131 determines how many convolution calculation circuits need to be turned on according to the difference between the total processing time (e.g., 1/60 second) and the total time of the first and second processing periods. At this period, the number of turned-on convolution calculation circuits may be less than the number of turned-on convolution calculation circuits in the first processing period and the number of turned-on convolution calculation circuits in the second processing period.

In the third processing period, the control circuit 131 not only considers the remaining processing time, but also considers the amount of data that needs to be processed (or the second calculation results) after the convolution operation is performed in the second processing period. In the third processing period, the control circuit 131 determines how many convolution calculation circuits need to be turned on according to the remaining processing time and the second calculation results before the convolution operation of each convolution layer is performed.

In some embodiments, the control circuit 131 comprises a storage circuit 133 to store a LUT or a machine learning model. In this case, before the convolution operation in each convolution layer is performed, the control circuit 131 determines the number of convolution calculation circuits to be turned on according to the information recorded in the storage circuit 133.

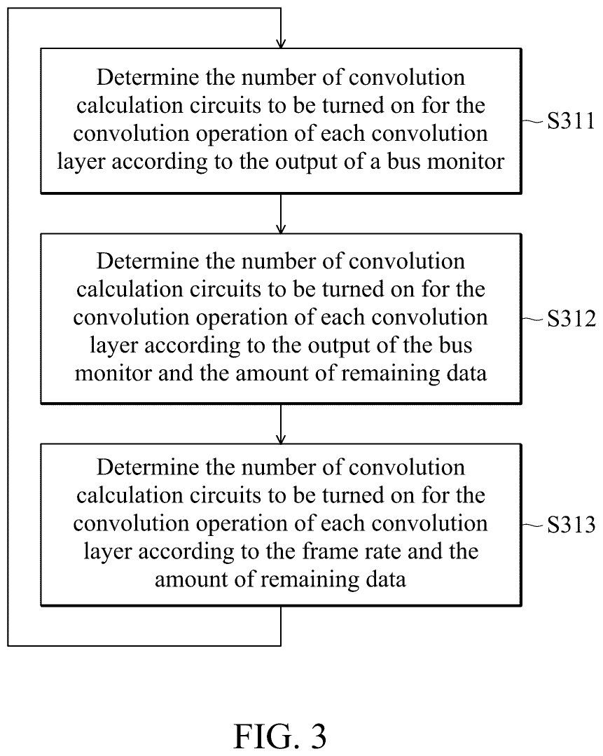

FIG. 3 is a flowchart of an exemplary embodiment of a control method for performing a convolution operation according to various aspects of the present disclosure. The control method for performing a convolution operation may take the form of a program code. When the program code is loaded into and executed by a machine such as a computer, the machine thereby becomes a micro-controller circuit and a convolution accelerator for practicing the control method.

First, the number of convolution calculation circuits to be turned on for the convolution operation of each convolution layer in a first processing period is determined according to the output of a bus monitor (step S311). In one embodiment, the bus monitor detects the access state of a storage circuit within a fixed time interval. The bus monitor may detect the idle time and the idle space of the storage circuit within a fixed time interval. In some embodiments, step S311 is performed to turn on some of convolution calculation circuits. The turned-on convolution calculation circuits perform the convolution operations of multiple convolution layers on picture data stored in the storage circuit.

Next, the number of convolution calculation circuits to be turned on for the convolution operation of each convolution layer in a second processing period is determined according to the output of the bus monitor and the amount of remaining data (step S312). In one embodiment, the amount of remaining data is the data amount of the calculation results (or referred to as the first calculation results) generated by the convolution operation in step S311. In this case, step S312 is performed to turn on some convolution calculation circuits to perform the convolution operation of each convolution layer on the calculation results generated in step S311. The number of turned-on convolution calculation circuits in the second processing period may be equal to or less than the number of turned-on convolution calculation circuits in the first processing period.

Then, the number of convolution calculation circuits to be turned on for the convolution operation of each convolution layer in a third processing period is determined according to the frame rate and the amount of remaining data (step S313). In one embodiment, the amount of remaining data is the amount of the calculation results generated by the convolution operation in step S312. In this case, step S313 is performed to turn on some convolution calculation circuits to perform the convolution operations of multiple convolution layers on the calculation results (or second calculation results) generated in step S312. The number of turned-on convolution calculation circuits in the third processing period may be less than the number of turned-on convolution calculation circuits in the second processing period.

In some embodiments, step S313 is performed to obtain the processing time according to the frame rate input by the user. In step S313, the total time of the first and second processing periods is calculated. Step S313 is performed to calculate the difference between the processing time and the total time of the first and second processing periods to obtain a remaining time value. In this case, step S313 is performed to determine the number of convolution calculation circuits to be turned on for the convolution calculation of each convolution layer in the third processing period according to the amount of the second calculation results and the remaining time value.

A Winograd algorithm, for example, may have sixteenth convolution layers. In this case, the convolution operations of the first to fourth convolution layers on an image data are performed in the first processing period. Since the amount of data of the convolution operations of the first to fourth convolution layers is large, step S311 is performed to turn on the maximum number of convolution calculation circuits according to the idle time and idle space of the storage circuit.

Then, in the second processing period, the convolution operations of the fifth to twelfth convolution layers are performed. At this time, the amount of remaining data is obtained according to the convolution results generated by the fourth convolution layer. The appropriate convolution calculation circuits are turned on according to the amount of remaining data, and the idle time and idle space of the storage circuit.

Finally, in the third processing period, the convolution operations of the thirteenth to sixteenth convolution layers are performed. At this time, the amount of remaining data is obtained according to the calculation results generated by the twelfth convolution layer. The minimum number of convolution calculation circuits are turned on according to the amount of remaining data and the remaining time. Since the amount of data for the convolution operations of the thirteenth to sixteenth convolution layers is the smallest, as long as the convolution operations of the thirteenth to sixteenth layers can be completed within the remaining time, the minimum number of convolution calculation circuits can be turned on. Therefore, the third processing period has the lowest power consumption.

By turning on appropriate convolution calculation circuits at different processing periods, the overall hardware utilization rate is improved. For example, when the bandwidth of the storage circuit is sufficient, more convolution calculation circuits are turned on to achieve high performance. The amount of remaining data is considered to turn on fewer convolution calculation circuits to reduce the power consumption.

Additionally,“enable” shall mean changing the state of a Boolean signal. Boolean signals may be enabled high or with a higher voltage, and Boolean signals may be enabled low or with a lower voltage, at the discretion of the circuit designer. Similarly, “disable” shall mean changing the state of the Boolean signal to a voltage level opposite the enabled state.

The control method for performing a convolution operation, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a micro-controller circuit and a convolution accelerator for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a micro-controller circuit and a convolution accelerator for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another. In the following claims, the terms “first,” “second,” etc. are used merely as labels, and are not intended to impose numerical requirements on their objects.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). For example, it should be understood that the system, device and method may be realized in software, hardware, firmware, or any combination thereof. Therefore, the scope of the appended claims should be accorded the broadest interpretation so as to encompass all such modifications and similar arrangements.

What is claimed is:

1. A convolution accelerator for performing convolution operations of a plurality of convolution layers on data stored in a storage circuit, comprising:
a plurality of convolution calculation circuits, wherein a convolution operation is performed in response to one of the convolution calculation circuits being turned on;
a detection circuit detecting an access state of the storage circuit within a fixed time interval to generate a detection signal; and
a control circuit dynamically adjusting the number of convolution calculation circuits to be turned on for the convolution operations of the convolution layers according to the detection signal.

2. The convolution accelerator as claimed in claim 1, wherein the access state is the idle time and free space of the storage circuit.

3. The convolution accelerator as claimed in claim 2, wherein:
in response to the idle time and the free space of the storage circuit within the fixed time interval matching a first predetermined condition, the control circuit turns on all the convolution calculation circuits,
in response to the idle time and the free space of the storage circuit within the fixed time interval matching a first predetermined condition, the control circuit turns on some of the convolution calculation circuits.

4. The convolution accelerator as claimed in claim 1, wherein:
in a first processing period, the control circuit turns on some of the convolution calculation circuits according to the detection signal before the convolution operation of each convolution layer is performed,
the turned-on convolution calculation circuits in the first processing period generate a plurality of first calculation results,
in a second processing period, the control circuit turns on some of the convolution calculation circuits according to the first calculation results before the convolution operation of each convolution layer is performed.

5. The convolution accelerator as claimed in claim 4, wherein the number of turned-on convolution calculation circuits in the first processing period is higher than the number of turned-on convolution calculation circuits in the second processing period.

6. The convolution accelerator as claimed in claim 4, wherein in the second processing period, the control circuit determines the number of convolution calculation circuits to be turned on according to the detection signal.

7. The convolution accelerator as claimed in claim 6, wherein:
in a third processing period:
the control circuit determines processing time according to a frame rate,
the control circuit calculates total time of the first processing period and the second processing period.
before the convolution operation of each convolution layer is performed, the control circuit turns on some of the convolution calculation circuits according to a difference between the processing time and the total time of the first processing period and the second processing period.

8. The convolution accelerator as claimed in claim 7, wherein the number of turned-on convolution calculation circuits in the third processing period is less than the number of turned-on convolution calculation circuits in the second processing period.

9. The convolution accelerator as claimed in claim 7, wherein:
in the second processing period, the turned-on convolution calculation circuits generate a plurality of second calculation results,
in the third processing period, the control circuit determines the number of convolution calculation circuits to be turned on according to the second calculation results and the difference between the processing time and the total time of the first processing period and the second processing period.

10. The convolution accelerator as claimed in claim 9, wherein the control circuit comprises a look-up table which records a plurality of calculation results and a plurality of time values, the control circuit determines the number of convolution calculation circuits to be turned on in the convolution operations of each of the convolution layers according to the look-up table, the first calculation result, and the difference between the processing time and the total time of the first processing period and the second processing period.

11. The convolution accelerator as claimed in claim 9, wherein:
the control circuit comprises a machine learning model, in a training period,
the control circuit inputs training data to the machine learning model to train the machine learning model to determine the number of convolution calculation circuits to be turned on in the convolution operations of each of the convolution layers in the first processing period, the second processing period and the third processing period.

12. The convolution accelerator as claimed in claim 1, wherein each of the convolution calculation circuits comprises:
an input buffer storing an input feature map and a plurality of weight values;
a processing engine circuit using a Winograd algorithm to calculate the input feature map and the weight values to generate a plurality output results;
an accumulator accumulating the output results to generate an accumulated result; and
an output buffer storing the accumulated result.

13. A micro-controller circuit, comprising:
a sensing circuit detecting an external image to generate input data;
a storage circuit storing the input data;
a convolution accelerator performing convolution operations of a plurality of convolution layers on the input data and comprising:
a plurality of convolution calculation circuits, wherein a convolution operation is performed in response to one of the convolution calculation circuits being turned on;
a detection circuit detecting an access state of the storage circuit within a fixed time interval to generate a detection signal; and
a control circuit dynamically adjusting the number of convolution calculation circuits to be turned on for the convolution operations of each of the convolution layers according to the detection signal; and
a processing circuit triggering the convolution accelerator and identifying the external image according to calculation results of the convolution calculation circuits.

14. The micro-controller circuit as claimed in claim 13, wherein the processing circuit performs a fully connected layer operation on the calculation results of the convolution calculation circuits.

15. The micro-controller circuit as claimed in claim 13, wherein:
in a first processing period, the control circuit turns on some of the convolution calculation circuits according to the detection signal before the convolution operation of each convolution layer is performed,
the turned-on convolution calculation circuits in the first processing period generate a first calculation result,
in a second processing period, the control circuit turns on some of the convolution calculation circuits according to an amount of data of the first calculation results before the convolution operation of each convolution layer is performed,
the turned-on convolution calculation circuits in the second processing period generate a second calculation result,
in a third processing period:
the control circuit determines processing time according to a frame rate,
the control circuit calculates the sum of the first processing period and the second processing period, and
before the convolution operation of each convolution layer is performed, the control circuit turns on some of the convolution calculation circuits according to a difference between the processing time and the total time of the first processing period and the second processing period.

16. The micro-controller circuit as claimed in claim 15, wherein:
in the second processing period, the control circuit turns on some of the convolution calculation circuits according to the detection signal and the amount of data of the first calculation result, and
in the third processing period, the control circuit turns on some of the convolution calculation circuits according to the amount of data of the second calculation results and the difference between the processing time and the total time of the first processing period and the second processing period.

17. The micro-controller circuit as claimed in claim 16, wherein the number of turned-on convolution calculation circuits in the first processing period is higher than the number of turned-on convolution calculation circuits in the second processing period, and the number of turned-on convolution calculation circuits in the second processing period is higher than the number of turned-on convolution calculation circuits in the third processing period.

18. The micro-controller circuit as claimed in claim 17, wherein each of the convolution calculation circuits receives an activation signal, and in response to the activation signal being enabled, a corresponding convolution calculation circuit is turned on to perform the convolution operation.

19. The micro-controller circuit as claimed in claim 17, wherein the control circuit uses a look-up table or a machine learning model to determine the number of convolution calculation circuits to be turned on in the first processing period, the second processing period and the third processing period.

20. A control method for performing convolution operations of a plurality of convolution layers, comprising:
storing picture data in a storage circuit;
detecting an access state of the storage circuit within a fixed time interval;
determining the number of convolution calculation circuits to be turned on in each convolution layer in a first processing period according to the access state;
detecting a plurality of first calculation results generated by the turned-on convolution calculation circuits in the first processing period;
determining the number of convolution calculation circuits to be turned on in each convolution layer in a second processing period according to the amount of data of the first calculation results and the access state;
detecting a plurality of second calculation results generated by the turned-on convolution calculation circuits in the second processing period;
detecting a frame rate to determine processing time;
calculating total time of the first processing period and the second processing period;
calculating a difference between the processing time and the total time of the first processing period and the second processing period; and
determining the number of convolution calculation circuits to be turned on in each convolution layer in a third processing period according to the amount of data of the second calculation results and the difference between the processing time and the total time of the first processing period and the second processing period.
